(19) United States
(12) Patent Application Publication
(10) Pub. No.: US 2003/0000753 A1
(43) Pub. Date: Jan. 2, 2003

(54) Radiator grille for motor vehicle

(76) Inventor: Wen Chi Shih, Keelung (TW)

Correspondence Address: Wen Chi Shih, No. 34, Lane 87, Fu I Street, Chi Tu, Keelung, 206, TW

(21) Appl. No.: 09/893,058

(22) Filed: Jun. 28, 2001

(51) Int. Cl. B60K 11/04

(52) U.S. Cl. 180/68.6; 180/68.1

(57) ABSTRACT

A radiator grille having two vertical end walls, two longitudinal series of openings respectively formed on the two vertical end walls, and a plurality of channel tile-like grille portions arranged in parallel between the vertical end walls and formed integral with one another, the channel tile-like grille portions having transversely extended openings for enabling the radiator grille to be curved for easy installation in any of a variety of motor vehicles.

### BACKGROUND OF THE INVENTION

The present invention relates to a radiator grille for motor vehicle and, more particularly, to such a radiator grille sensor, which has a three-dimensional profile, fits different vehicle radiators, and is inexpensive to manufacture.

Following fast development of economics, to have a motor vehicle is no longer a wild hope of a family nowadays in many countries around the world. Various motor vehicles are commercially available. These motor vehicles commonly have a radiator for cooling the engine. Different motor vehicles are equipped with a different grille to protect the radiator. Because different radiator grilles must be used to fit different motor vehicles, the manufacturing cost of radiator grilles is high. Further, conventional radiator grilles are flat members that do not have a three-dimensional profile.

### SUMMARY OF THE INVENTION

It is one object of the present invention to provide a radiator grille, which fits any of a variety of motor vehicle radiators.

It is another object of the present invention to provide a radiator grille, which has a three-dimensional profile.

It is still another object of the present invention to provide a radiator grille, which is inexpensive to manufacture.

According to the present invention, the radiator grille comprises two vertical end walls, two longitudinal series of openings respectively formed on the two vertical end walls, and a plurality of channel tile-like grille portions arranged in parallel between the vertical end walls and formed integral with one another. The channel tile-like grille portions each comprises two vertical walls, a horizontal wall connected between the vertical walls, a plurality of arched holes symmetrically formed on the vertical walls and arranged in a longitudinal line on each of the vertical walls, and a plurality of elongated slots obliquely transversely formed on the horizontal wall and arranged in parallel and respectively connected between the arched holes on the vertical walls.

The radiator grille can be cut subject to the desired size to fit any of a variety of motor vehicle radiators. The holes and slots enable the radiator grille to be bent into a smoothed arched shape for easy installation in any of a variety of motor vehicles. Further, the channel tile-like grille portions show a three-dimensional profile.

### BRIEF DESCRIPTION OF THE DRAWINGS

FIG. 1 is a perspective view of a radiator grille according to the present invention.

FIG. 2 illustrates the radiator grille of the present invention installed in a motor vehicle.

FIG. 3 is a front view in section of the radiator grille according to the present invention.

FIG. 4 is another sectional front view of the present invention, showing the radiator grille curved.

FIG. 5 is a side plain view of the radiator grille according to the present invention.

FIG. 6 is another side plain view of the present invention, showing the radiator grille curved.

### DETAILED DESCRIPTION OF THE PREFERRED EMBODIMENT

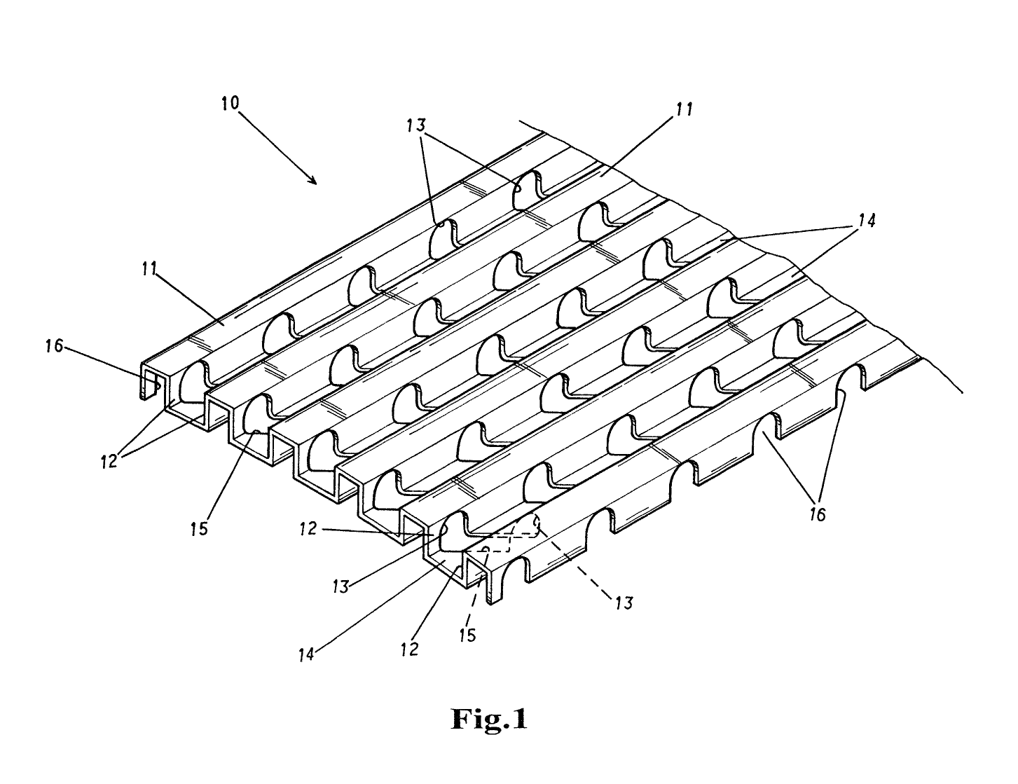

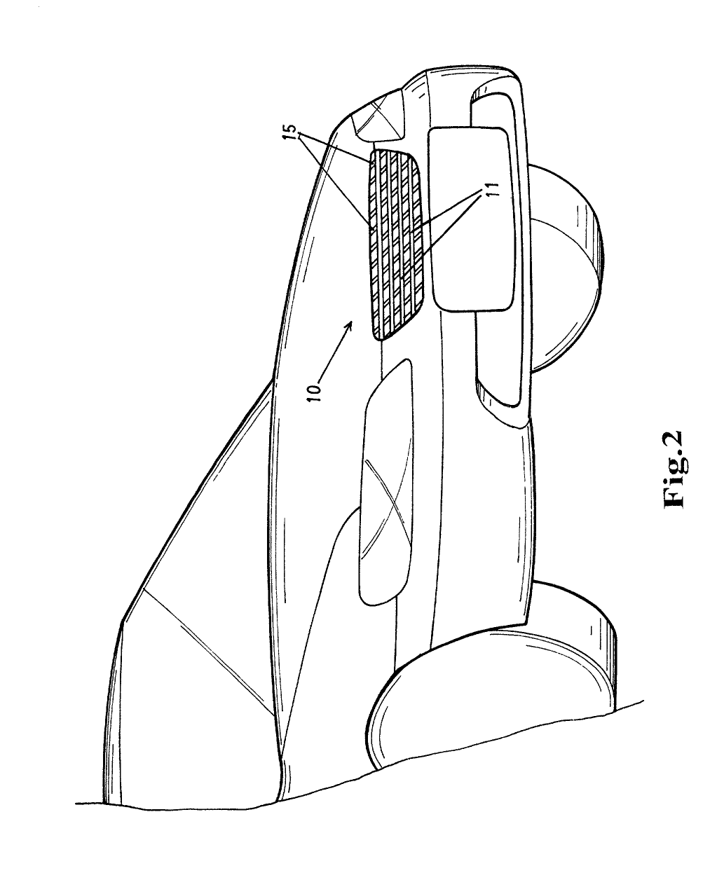

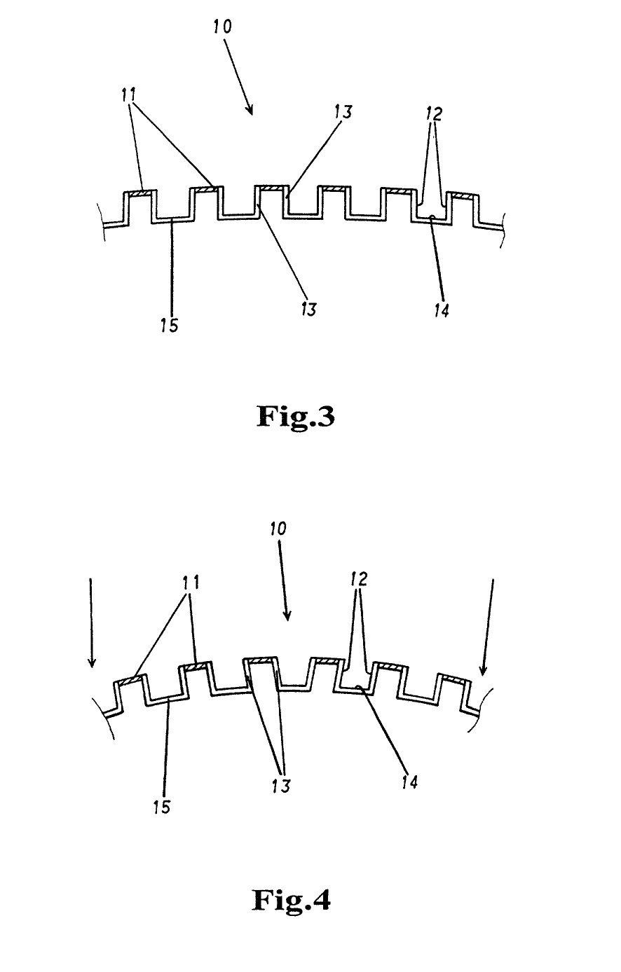

Referring to FIGS. 1 and 2, a radiator grille 10 in accordance with the present invention is a corrugated sheet member comprising a plurality of channel tile-like grille portions 11 arranged in parallel and formed integral with one another. Each channel tile-like grille portion 11 comprises two vertical walls 12, a horizontal wall 14 connected between the vertical walls 12, arched holes 13 symmetrically formed on the vertical walls 12 and arranged in a longitudinal line on each vertical wall 12, elongated slots 15 obliquely transversely formed on the horizontal wall 14 and arranged in parallel and respectively connected between the arched holes 13 on the vertical walls 12. The radiator grille 10 further comprises two longitudinal series of openings 16 respectively formed on the two vertical end walls thereof.

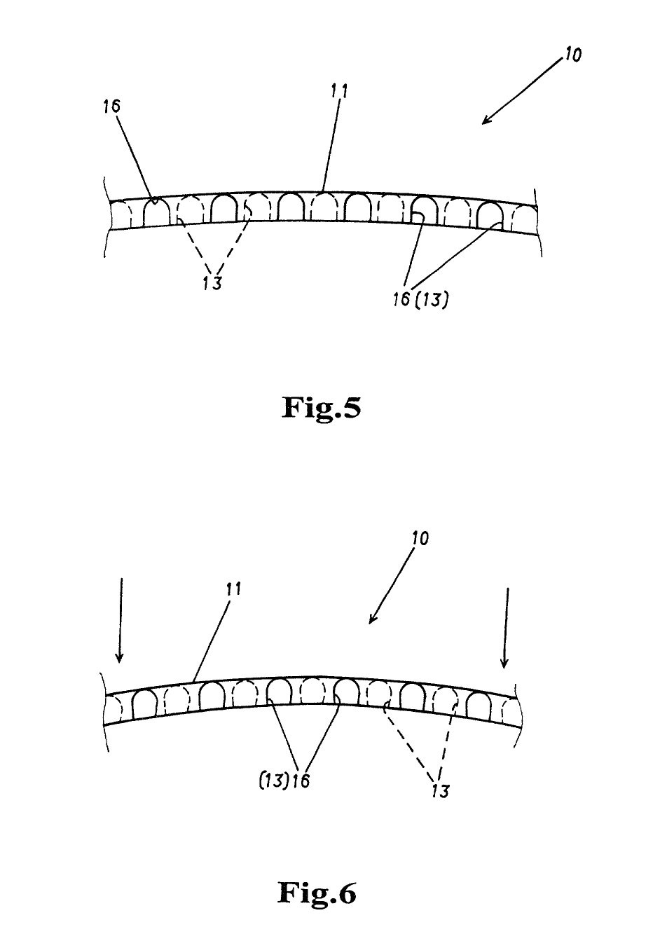

Referring to FIGS. from 3 through 6 and FIG. 2 again, the radiator grille 10 is properly cut subject to a predetermined shape to fit the radiator of the motor vehicle, and then the left and right ends of the well-cut radiator grille 10 are bent downwards to curve the radiator grille 10 for enabling the radiator grille 10 to be inserted into the opening for radiator grille on the front side of the motor vehicle and then set into position. Because the radiator grille 10 has arched holes 13 and elongated slots 15 on its channel tile-like grille portions 11 and openings 16 on its two vertical end walls thereof, it can be smoothly curved into an arched status as shown in FIGS. 5 and 6, and then installed in the motor vehicle to protect the radiator. When installed, the radiator grille 10 protect the radiator against pebbles and external objects, and the arched holes 13 and elongated slots 15 work as air vents to guide outside cooling air to the surface of the radiator, enabling the radiator to the engine of the motor vehicle efficiently.

A prototype of radiator grille has been constructed with the features of FIGS. 1˜6. The radiator grille functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A radiator grille comprising two vertical end walls, two longitudinal series of openings respectively formed on said two vertical end walls, and a plurality of channel tile-like grille portions arranged in parallel between said vertical end walls and formed integral with one another, said channel tile-like grille portions each comprising two vertical walls, a horizontal wall connected between said vertical walls, a plurality of arched holes symmetrically formed on said vertical walls and arranged in a longitudinal line on each of said vertical walls, and a plurality of elongated slots obliquely transversely formed on said horizontal wall and arranged in parallel and respectively connected between said arched holes on said vertical walls.
